(19) United States
(12) Patent Application Publication
(10) Pub. No.: US 2023/0258800 A1
(43) Pub. Date: Aug. 17, 2023

(54) CHECKING THE POSITIONING OF AN ULTRASONIC SENSOR ON A VEHICLE

(71) Applicant: Valeo Schalter und Sensoren GmbH, Bietigheim-Bissingen (DE)

(72) Inventor: Fabian Haag, Bietigheim-Bissingen (DE)

(73) Assignee: Valeo Schalter und Sensoren GmbH, Bietigheim-Bissingen (DE)

(21) Appl. No.: 18/026,449

(22) PCT Filed: Sep. 2, 2021
(86) PCT No.: PCT/EP2021/074198

§ 371 Date: Mar. 15, 2023

(30) Foreign Application Priority Data
Sep. 15, 2020 (DE) 10 2020 124 013.9

(51) Int. Cl. G01S 15/931; G01S 7/527; G01S 15/86

(52) U.S. Cl. CPC G01S 15/931; G01S 7/527; G01S 15/86; G01S 2015/937; G01S 2015/465

(57) ABSTRACT

A method for checking the positioning of an ultrasonic sensor installed in a mounting on the vehicle is disclosed. The method involves localizing a reference object in the detection region of the ultrasonic sensor, emitting at least one first ultrasonic pulse with a first ultrasonic frequency, receiving at least one first echo signal at the first ultrasonic frequency, emitting at least one second ultrasonic pulse with a second ultrasonic frequency, receiving at least one second echo signal at the second ultrasonic frequency, ascertaining the ratio of echo amplitudes of the reference object in the at least one first and second echo signal, and outputting an incorrect positioning of the ultrasonic sensor if the ratio of echo amplitudes in the reference object in the at least one first and second echo signal deviates from the ratio for a correct positioning of the ultrasonic sensor by at least one specified threshold.

The present invention relates to a method for checking the positioning of an ultrasonic sensor on a vehicle, wherein the ultrasonic sensor is installed in a mounting bracket on the vehicle.

The invention also relates to a sensor assembly having at least one ultrasonic sensor and a control unit, which is connected via a data connection to the at least one ultrasonic sensor, wherein the at least one ultrasonic sensor is installed in a mounting bracket on the vehicle, wherein the sensor assembly is designed to carry out the above method for checking the positioning of an ultrasonic sensor on a vehicle.

The use of ultrasonic sensors for vehicle driving assistance systems is a common feature in current vehicles. The ultrasonic sensors are arranged, for example, on a front and/or rear fender of the vehicle for monitoring an environment of the vehicle. In addition, ultrasonic sensors are also used in side regions of the vehicles. Sensor information of the sensors can be used, for example, in a near-field monitoring system, in particular a parking assistance system or a blind spot monitoring system.

In the prior art, such ultrasonic sensors are usually fixed by means of mounting brackets that are arranged or designed to be arranged on the vehicle. Due to the simple and fast mounting, a snap-fit mounting of the ultrasonic sensors in the brackets is commonly used.

As a result, there is a risk, both during production and during repairs in an auto repair shop, that the ultrasonic sensors do not engage correctly with the latching structures during installation and are therefore not correctly positioned in the mounting bracket and thus on the vehicle. The longitudinal axes of the ultrasonic sensor and the associated bracket will then differ accordingly. It is not guaranteed that the ultrasonic sensors are located in their intended installation position, for example, due to their elevation angles and/or azimuth angles being incorrect. Deviations from the intended installation position may also occur due to collisions or intentional damage.

On the one hand, this can cause a detection region of the incorrectly mounted ultrasonic sensor to be misaligned. In addition, faults can occur on the ultrasonic sensor if an ultrasonic diaphragm of the incorrectly mounted ultrasonic sensor is restricted in its movement, for example, if it is in contact with a diaphragm holder of the mounting bracket.

As a result of incorrectly mounted ultrasonic sensors, in addition to the above-mentioned parking assistance system or the blind spot monitoring system, other safety-relevant functions such as pedestrian detection or autonomous or semi-autonomous maneuvering can also be impaired or become inoperative. A particular disadvantage is that neither the ultrasonic sensor itself nor an assistance system to which this ultrasonic sensor belongs can detect and/or signal incorrectly mounted ultrasonic sensors. On the contrary, the ultrasonic sensor itself, as well as the driving assistance system to which this ultrasonic sensor belongs, will assume a supposedly correct operation.

In this context, DE 10 2010 024 205 A1 discloses an ultrasonic sensor, in particular for a vehicle, having a pot-shaped housing and a cover which covers the housing at the rear. For example, the cover can be designed as a foil.

Document DE 10 2013 022 061 A1 discloses a method for producing an ultrasonic sensor for a motor vehicle, in which the ultrasonic sensor is provided with a diaphragm for emitting ultrasonic signals in a transmission direction and a sensor housing, in and/or to which the diaphragm is fixed. The sensor housing has a front side, which points in the emitting direction of the diaphragm, and a rear side, which points in a rearward direction which is opposite to the emitting direction, and wherein the sensor housing is formed on the front side with a front-side opening for the diaphragm, wherein the front side of the sensor housing is connected to a cap made from a foil, with which the front-side opening of the sensor housing is covered in the emitting direction, and wherein the diaphragm is at least partially inserted into a receptacle of the cap and thus a front side of the diaphragm, which points in the emitting direction of the diaphragm, is connected to a base of the receptacle of the cap.

Further, an ultrasonic sensor, in particular for a vehicle, as well as a method for producing an ultrasonic sensor and a motor vehicle having an ultrasonic sensor, are known from DE 10 2013 213 476 A1. The ultrasonic sensor comprises a transducer element arranged in a housing part, and a cover part, wherein an electronic circuit is arranged on the cover part and the housing part is connectable or connected to the cover part.

Based on the above-mentioned prior art, the object of the invention is therefore to specify a method for checking the positioning of an ultrasonic sensor on a vehicle, wherein the ultrasonic sensor is installed in a mounting bracket on the vehicle, and a sensor assembly having at least one ultrasonic sensor and a control unit which is connected via a data connection to the at least one ultrasonic sensor, wherein said method and assembly allow the detection of an incorrect positioning of ultrasonic sensors.

The object is achieved according to the invention by the features of the independent claims. Advantageous configurations of the invention are specified in the dependent claims.

According to the invention, a method is therefore specified for checking the positioning of an ultrasonic sensor on a vehicle, wherein the ultrasonic sensor is installed in a mounting bracket on the vehicle, which method comprises the steps of localizing a reference object in the detection region of the ultrasonic sensor, emitting at least one first ultrasonic pulse with a first ultrasonic frequency by means of the ultrasonic sensor, receiving at least one first echo signal at the first ultrasonic frequency by means of the ultrasonic sensor, emitting at least one second ultrasonic pulse with a second ultrasonic frequency by means of the ultrasonic sensor, receiving at least one second echo signal at the second ultrasonic frequency by means of the ultrasonic sensor, ascertaining a ratio of echo amplitudes of the reference object in the at least one first and second echo signal, and outputting an error in the positioning of the ultrasonic sensor if the ratio of the echo amplitudes of the reference object in the at least one first and second echo signal deviates from the ratio for a correct positioning of the ultrasonic sensor by at least one specified threshold value.

The invention also relates to a sensor assembly having at least one ultrasonic sensor and a control unit, which is connected via a data connection to the at least one ultrasonic sensor, wherein the at least one ultrasonic sensor is installed in a mounting bracket on the vehicle, wherein the sensor assembly is designed to carry out the above method for checking the positioning of an ultrasonic sensor on a vehicle.

The basic idea of the present invention is therefore to exploit an established frequency dependence of the detection region of the ultrasonic sensors to check the positioning of the ultrasonic sensor by emitting ultrasonic signals and receiving corresponding echo signals with different frequencies by using the ultrasonic sensor itself. The detection region defines a region that is both captured by ultrasonic signals emitted by the ultrasonic sensor and from which echo signals with echoes of objects based on the emitted ultrasonic signals can be received. For example, the ultrasonic sensor typically has a lobe-shaped detection region, which usually extends symmetrically around a sensor axis. The sensor axis defines a central region of the ultrasonic sensor that, for a correctly positioned and/or mounted state of the ultrasonic sensor, corresponds to a central axis of the mounting bracket. At high frequencies, the detection region is narrower than at low frequencies. In addition, the amplitudes of echoes caused by objects in the detection region are attenuated at low frequencies with an incorrectly positioned ultrasonic sensor compared to a correctly positioned one. These effects can be used to determine correct or incorrect positioning of the ultrasonic sensor based on a ratio of the echo amplitudes of the reference object in the first and second echo signals. When the ultrasonic sensor is correctly positioned, the echo amplitudes of the reference object in the first and second echo signal are essentially equal due to an appropriate calibration. However, a deviation is produced if the ultrasonic sensor is positioned incorrectly in the mounting bracket. Corresponding differences in the amplitudes can be detected for arbitrary positions of the reference object in the detection region of the ultrasonic sensor.

The differences in the detection region between incorrect and correct positioning of the ultrasonic sensor are based on two effects. Firstly, the sensor axis is tilted out of its target position, which usually corresponds to a central axis of the mounting bracket, so that the detection region is also tilted relative to it. The detection region of the ultrasonic sensor is therefore misaligned. In addition, faults occur if an ultrasonic diaphragm of the incorrectly positioned ultrasonic sensor is restricted in its movement, for example, if it is in contact with a diaphragm holder of the mounting bracket. This is often the case when the ultrasonic sensor is positioned incorrectly because the ultrasonic sensor is not correctly held in the mounting bracket. This allows the shape and orientation of the detection region to be further modified. In particular, these perturbations depend to a large extent on a relationship between geometric dimensions and an ultrasound frequency of the ultrasonic sensor. In particular, in a peripheral region of the detection region, the frequency has a strong effect on the sensitivity. If the ultrasonic sensor is positioned incorrectly, the echo amplitudes of the reference object in the echo signals will thus differ particularly significantly at the two frequencies.

The detection region here defines a region in which an echo of the reference object can be received. This means that both the ultrasonic signals can be radiated into the detection region and the echo signals can be received with echoes from the detection region. The detection region is related to each ultrasonic sensor and has a different shape and orientation when the ultrasonic sensor is correctly positioned than when the sensor is incorrectly positioned. The central axis of the mounting bracket typically defines a target position of the ultrasonic sensor, i.e. an alignment of the sensor axis with the central axis of the bracket corresponds to a correct positioning of the ultrasonic sensor. In order to compare the echo amplitudes of the reference object for the first and second ultrasonic frequencies, both echo signals must detect the reference object, i.e. the reference object must lie within the detection region for both ultrasonic frequencies.

The ultrasonic sensor mounting bracket is typically fixed to the vehicle, such as on a front or rear fender of the vehicle or in a side region of it. The ultrasonic sensor is often installed in its mounting bracket and thus positioned by means of a snap-in mounting, due to the simple and fast installation this provides. In principle, however, other methods of mounting the ultrasonic sensor in the mounting bracket are also possible.

The method is carried out under the control of the control unit. In principle, the control unit can be any desired data processing device. In the automotive sector, so-called embedded systems are often used. The term ECU (Electronic Control Unit) is used for such control units.

The ultrasonic sensor is connected to the control unit via the data link. The data link can comprise a bus, for example in the form of a DSI3 bus, CAN bus, FlexRay or as a proprietary implementation. In principle, however, a direct connection between the control unit and the ultrasonic sensor is also possible.

The sensor arrangement can comprise essentially any number of ultrasonic sensors, which are arranged on the vehicle at any desired positions in corresponding mounting brackets. A plurality of ultrasonic sensors are then distributed on a rear and/or front of the vehicle. Ultrasonic sensors are also increasingly commonly mounted on the sides of vehicles. Then, each of the ultrasonic sensors of the sensor assembly can be individually controlled by the control unit in order to carry out the specified method.

Localizing a reference object in the detection region of the ultrasonic sensor involves detecting a suitable reference object in the detection region. In order to avoid complex laboratory setups, in principle any objects that are located in the detection region can be considered as reference objects. In order to be able to carry out the method reliably, the reference object for carrying out the method is considered to be static, i.e. it does not move relative to the vehicle on which the ultrasonic sensor is mounted. The method is therefore usually carried out when the vehicle is stationary. In the course of a repair in a workshop, however, a reference object can also be intentionally positioned in the detection region in order to carry out the method.

Based on this, the method can be started intentionally in the workshop, for example, by means of an interaction via an operator interface of the control unit. Alternatively, the method can be carried out by the control unit at specified, arbitrarily calculated or even randomly selected intervals, in order to ensure the correct function of each connected ultrasonic sensor and moreover to ensure the continuous functioning of higher-level driving assistance systems.

The localization of the object essentially involves the detection of an object that is suitable as a reference object, i.e. the object must be in the detection region of the ultrasonic sensor. Preferably, the narrowest detection region of the ultrasonic sensor is assumed based on the ultrasonic frequencies used. In addition, a position of the reference object can be determined, for example, as an angular position of the reference object relative to the central axis of the mounting bracket and/or as a distance to the ultrasonic sensor. Further details are given below.

To carry out the method, the ultrasonic sensor is operated with two different ultrasonic frequencies, i.e. with the first and with the second ultrasonic frequency, so that one ultrasonic frequency must be lower than the other. At least one first ultrasonic pulse with a first ultrasonic frequency is emitted using the ultrasonic sensor and then the corresponding echo signal with the echo amplitude of the reference object is received. The same applies correspondingly to the second ultrasonic frequency. The use of the different ultrasonic frequencies results in the different echo amplitudes of the reference object in the first and second echo signals.

Each of the echo signals can contain additional echoes from the environment of the ultrasonic sensor, for example as ground echoes. These echoes are not discussed further here and often have echo amplitudes that are significantly below the echo amplitude of the reference object.

The ultrasonic sensor can emit individual ultrasonic pulses and receive the corresponding echo signals, or the ultrasonic sensor emits pulse sequences of individual ultrasonic pulses in each case, and receives a corresponding echo signal.

The sequence of the emission of first and second ultrasonic pulses is essentially arbitrary and can be carried out, for example, when emitting multiple independent ultrasonic pulses of the first and/or second ultrasonic frequency in any sequence, including mixed ones. The ultrasonic sensor is accordingly adjusted in its frequency response in order to emit the ultrasonic pulses via its ultrasonic diaphragm and to couple in the corresponding echo signals.

Receiving the respective echo signal involves receiving raw sensor data, which is provided in this form for further processing in order to be able to determine the ratio of the echo amplitudes of the reference object. In principle, pre-processing of the raw sensor data is possible, for example using a filter. Accordingly, the raw data is transferred from the ultrasonic sensor to the control unit in which the further steps of the method are carried out.

Determining a ratio of echo amplitudes of the reference object in the at least one first and second echo signals relates in particular to the echo amplitudes originating from the reference object. These echo amplitudes of the reference object are usually detectable as peaks in an amplitude curve of the respective received echo signal over time. For example, the ratio is determined as the amplitude of the received echo signal at the lower ultrasound frequency divided by the amplitude of the received echo signal at the higher ultrasound frequency. In this case, an error in the positioning of the ultrasonic sensor is detected from the fact that the ratio of the echo amplitudes of the reference object in the at least one first and second echo signal is lower by at least one specified threshold value than for a correct positioning of the ultrasonic sensor. However, the ratio can also be determined in the reverse manner, whereby the incorrect positioning of the ultrasonic sensor can be detected from the fact that the ratio of the echo amplitudes of the reference object in the at least one first and second echo signal is higher by at least one specified threshold value than for a correct positioning of the ultrasonic sensor.

The sequence of method steps shown here is only one example. The steps can be carried out in different sequences without any fundamental changes to the method.

In an advantageous configuration of the invention, the localizing of a reference object in the detection region of the ultrasonic sensor comprises detecting a position of the reference object in the detection region of the ultrasonic sensor based on echo signals received using a plurality of ultrasonic sensors. The sensor arrangement accordingly comprises a plurality of ultrasonic sensors which have partially overlapping detection regions, so that the reference object can be detected by multiple ultrasonic sensors. The plurality of ultrasonic sensors may or may not include the ultrasonic sensor of which the positioning is to be checked. In total, different configurations are possible to detect the position of the reference object in the detection region of the ultrasonic sensor using the plurality of ultrasonic sensors. For example, each of the ultrasonic sensors can independently emit ultrasonic signals and receive echo signals based on them. Also, when an ultrasonic signal is emitted from one of the ultrasonic sensors, multiple ultrasonic sensors can receive echo signals based on that signal, provided that the ultrasonic sensors are synchronized. The echo signals can be processed as raw data. Alternatively, it may be sufficient to detect and process distance information related to the reference object in the echo signal in order to detect the position of the reference object. Preferably, adjacent ultrasonic sensors are used in this case, so that at least a partial overlap of their detection regions exists and echoes of the reference object can be received from a plurality of ultrasonic sensors. Based on the received echo signals, for example, known methods of multilateration, in particular trilateration, can be used to detect the position of the reference object in the detection region of the ultrasonic sensor. Preferably, based on the echo signals received it is ascertained whether the object is suitable as a reference object. For this purpose, a height estimation for the object can be carried out in a known manner based on the received echo signals. The reference object is preferably located in the same height range as the ultrasonic sensor. In addition, based on the echo signals received, a detection of walls can be carried out in a known manner, i.e. whether the object has a large width.

In an advantageous configuration of the invention the localizing of a reference object in the detection region of the ultrasonic sensor comprises emitting at least one focused ultrasonic pulse by means of the ultrasonic sensor having a narrow detection region, and receiving at least one corresponding echo signal by means of the ultrasonic sensor, wherein the reference object is localized by finding an echo of the reference object contained in the at least one received echo signal in the detection region of the ultrasonic sensor. As already mentioned above, the detection region of the ultrasonic sensor is dependent on the frequency, with the detection region being narrower and thus focused at higher frequencies. This results in a directional characteristic of the ultrasonic sensor compared to lower frequencies. Thus, if a corresponding echo signal is received based on the focused ultrasound signal, i.e. the ultrasound signal has a high frequency with a narrow beam lobe and a high directional characteristic, and an echo of the object is found in the echo signal, the object has a suitable positioning as a reference object, which means it will also be able to be found in the wider detection region for lower frequencies. If the reference object is located in the narrow detection region, the method can therefore be continued. It is ensured that the reference object is located, at least for ultrasound pulses with a wider detection region, in a central region of the corresponding detection region. Due to the focusing of the ultrasonic signal, the reference object is preferably located at a distance from the ultrasonic sensor such that it can also be detected with less focused ultrasonic signals at lower frequencies.

Preferably, the localization of a reference object is based on the emission of the at least one first or second ultrasonic pulse with the first or second ultrasonic frequency using the ultrasonic sensor and the reception of the corresponding echo signal. Depending on which ultrasonic signal has the higher frequency, the emission of this ultrasonic signal represents the emission of the at least one focused ultrasonic pulse with a narrow detection region. Therefore, it is advantageous to emit the at least one ultrasonic signal with the higher frequency first in order to localize the reference object, so that no additional ultrasonic pulses need to be emitted for the localization. This applies at least provided the reference object is located in the narrow detection region. The emitting of at least one focused ultrasonic pulse with the ultrasonic sensor with a narrow detection region can correspond, for example, to an operation of the ultrasonic sensor with a nominal frequency. Alternatively, the at least one focused ultrasonic pulse is emitted at a frequency above the nominal frequency. The only important factor is that at least the first or the second ultrasonic frequency is not higher than the frequency used for emitting the at least one focused ultrasonic pulse. Preferably, the first and the second ultrasonic frequency are not higher than the frequency used in emitting the at least one focused ultrasonic pulse, if the at least one focused ultrasonic pulse is neither the at least one first nor the at least one second ultrasonic pulse.

In an advantageous configuration of the invention the localizing of a reference object in the detection region of the ultrasonic sensor comprises detecting a position of the reference object in the detection region of the ultrasonic sensor based on a detection of the surroundings using at least one environment sensor from an optical camera, a LiDAR-based environment sensor and a radar sensor. This means that sensor information of additional environment sensors located on the vehicle is used to detect the position of the reference object. The above statements regarding the determination of the position of the reference object apply accordingly.

In an advantageous configuration of the invention the method comprises an additional step for positioning the reference object in a central region of the detection region of the ultrasonic sensor, preferably in an angular range of +/−15°, further preferably in an angular range of +/−10°, and particularly preferably in an angular range of +/−5°, in particular at an angle of approximately 0° relative to a central axis of the mounting bracket of the ultrasonic sensor. In the central region of the detection region, the ratio of the echo amplitudes of the reference object in the at least one first and second echo signal is particularly meaningful. It also prevents the reference object from being located on the edge of the detection region and possibly not being detected by the first or second ultrasound signal. The central region is defined by the sensor axis of the ultrasonic sensor or the central axis of the mounting bracket. The angular range relates to an orientation in a horizontal plane. The positioning of the reference object in a central region of the ultrasonic sensor detection region can involve excluding objects that are located outside the central region. Advantageously, however, the positioning is carried out in such a way that an instruction to move the vehicle and/or the reference object is output in order to position the reference object accordingly. The reference object is therefore preferably positioned in conjunction with the localization of the reference object in the detection region of the ultrasonic sensor. Accordingly, the positioning can be repeated as necessary until the reference object is positioned in the central region. Particularly preferably, the vehicle autonomously carries out a positioning relative to the reference object in order to position the reference object in the central region.

In an advantageous configuration of the invention at least one of the first ultrasonic frequency and the second ultrasonic frequency is in a frequency range below a nominal frequency of the ultrasonic sensor, and the corresponding other ultrasonic frequency is above the first ultrasonic frequency, in particular above the nominal frequency. A frequency difference between the first and second ultrasonic frequencies is particularly relevant. However, with conventional ultrasonic sensors, it has proven advantageous if the first or the second ultrasonic frequency is lower than the nominal frequency of the ultrasonic sensor. More advantageously, the other ultrasonic frequency is higher than the nominal frequency of the ultrasonic sensor. Particularly preferably, the values of the first and the second ultrasonic frequency are equally spaced from the nominal frequency. For example, the use of approximately 46 kHz and 59 kHz as the first and second ultrasonic frequencies has proven to be advantageous. The use of approximately 49 kHz and 55 kHz as the first and second ultrasonic frequencies has also proved to be effective. The same applies to frequencies between the specified values. The use of approximately 49 kHz and 55 kHz as the first and second ultrasonic frequency is possible with common ultrasonic sensors in a standard operating mode of a typical ultrasonic sensor and is therefore particularly simple to implement. A typical nominal frequency of the ultrasonic sensor is in the range between 49 kHz and 55 kHz, in particular at approximately 52 kHz.

In an advantageous configuration of the invention, the method comprises repeatedly emitting the at least one first ultrasonic pulse and/or the at least one second ultrasonic pulse and repeatedly receiving the at least one first echo signal and/or the at least one second echo signal, and ascertaining a ratio of echo amplitudes of the reference object in the at least one first and second echo signal comprises ascertaining the ratio of the echo amplitudes of the reference object based on a plurality of first and second echo signals. This allows statistical methods to be used to determine the echo amplitudes of the reference object in the at least one first and second echo signal and/or the ratio of the echo amplitudes of the reference object based on a plurality of first and second echo signals. Accordingly, echo amplitudes of the reference object in the at least one first and second echo signal and/or the ratio of the echo amplitudes can be determined, for example, as mean values, as weighted mean values and/or as median values. Thus, the echo amplitudes of the reference object in the at least one first and second echo signal can be determined firstly as specified, so that based on this, the ratio of the amplitudes of the first and second echo signal can be formed. Alternatively, for any combination of first and second echo signals, a single ratio can first be determined, the ratio then being determined based on the single ratios. By using a plurality of echo signals, a higher confidence can be achieved for the ratio of the echo amplitudes of the reference object in the at least one first and second echo signal and hence for the correct positioning of the ultrasonic sensor. By increasing the confidence in the echo amplitude ratio, false detection of an incorrect positioning of the ultrasonic sensor can be reliably avoided. For example, the limit value can be chosen particularly close to the ratio for a correct positioning of the ultrasonic sensor.

In an advantageous configuration of the invention, the method comprises a step for ascertaining a position of the reference object in the detection region of the ultrasonic sensor, and the output of an error in the positioning of the ultrasonic sensor comprises outputting an error in the positioning of the ultrasonic sensor if the ratio of the echo amplitudes of the reference object in the at least one first and second echo signal deviates by at least one specified threshold value from the ratio for a correct positioning of the ultrasonic sensor, which is dependent on the position of the reference object in the detection region of the ultrasonic sensor.

In an advantageous configuration of the invention, the method comprises a step for ascertaining a position of the reference object in the detection region of the ultrasonic sensor, and the output of an error in the positioning of the ultrasonic sensor comprises outputting an error in the positioning of the ultrasonic sensor if the ratio of the echo amplitudes of the reference object in the at least one first and second echo signal deviates from the ratio for a correct positioning of the ultrasonic sensor by at least one specified threshold value, which is dependent on the position of the reference object in the detection region of the ultrasonic sensor.

The above two cases relate to a position-dependent evaluation of the echo amplitudes of the reference object in the received echo signals. Thus, even in the case of a correct positioning of the ultrasonic sensor, it follows that the ratio of the echo amplitudes of the reference object in the at least one first and second echo signal can be dependent on a positioning of the reference object. While for a narrow angular range around the sensor axis the ratio of the echo amplitudes of the reference object in the at least one first and second echo signal is found to be approximately one, deviations can already occur when the positions are different. In order to be able to check the positioning of the ultrasonic sensor particularly reliably, the position of the reference object is therefore taken into account, either by the ratio for a correct positioning being dependent on the position of the reference object, or by the threshold value being dependent on the position of the reference object. In particular, the position of the reference object is an angular position in the horizontal plane. With a combination of both the ratio for correct positioning and the threshold value being dependent on the position of the reference object, only one position of the reference object should therefore need to be determined.

The invention is explained in more detail below with reference to the attached drawing based on preferred embodiments. The features shown may each represent an aspect of the invention both individually and in combination. Features of different exemplary embodiments can be transferred from one exemplary embodiment to another.

In the figures:

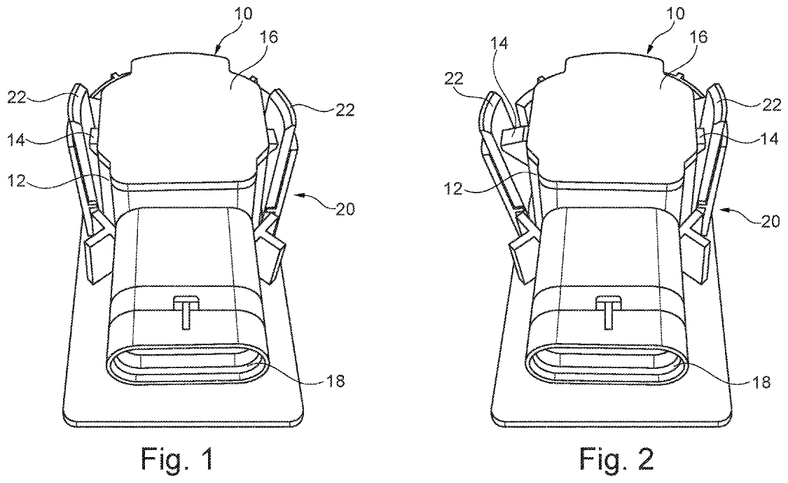

FIG. 1 shows a schematic view of an ultrasonic sensor according to a first, preferred embodiment in a mounting bracket, wherein the ultrasonic sensor is correctly positioned and engaged in the mounting bracket,

FIG. 2 shows a schematic view of the ultrasonic sensor in the mounting bracket according to the illustration in FIG. 1, wherein the ultrasonic sensor is positioned incorrectly and not fully engaged in the mounting bracket,

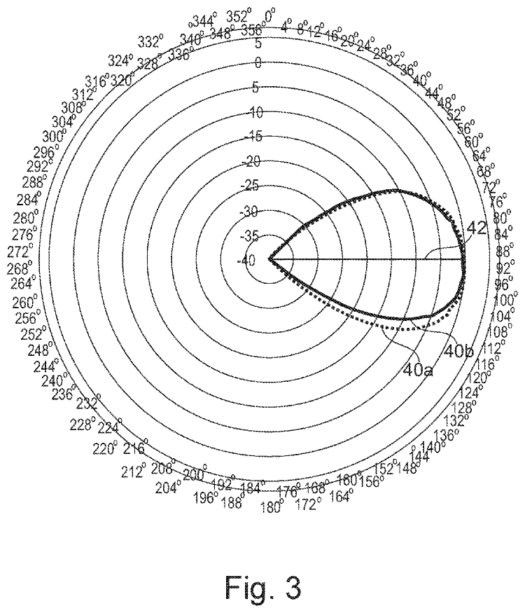

FIG. 3 shows a diagram of the detection regions of the ultrasonic sensor which is correctly positioned and engaged in the mounting bracket in accordance with FIG. 1, and of the ultrasonic sensor which is incorrectly positioned in the mounting bracket in accordance with FIG. 2 and is accordingly not fully engaged in it, at a medium ultrasonic frequency,

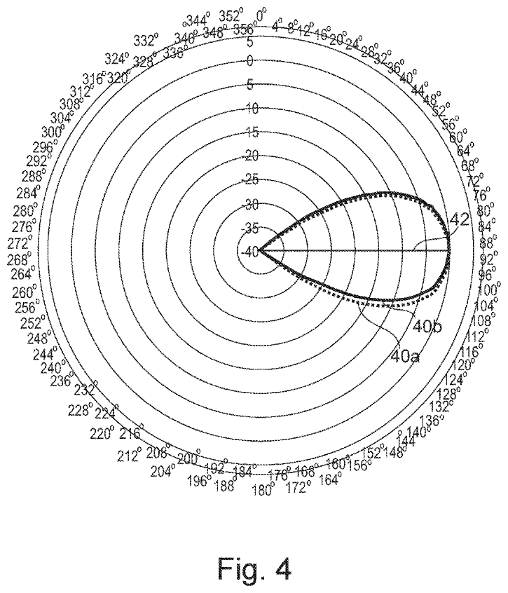

FIG. 4 shows a diagram of the detection regions of the ultrasonic sensor which is correctly positioned and engaged in the mounting bracket in accordance with FIG. 1, and of the ultrasonic sensor which is incorrectly positioned in the mounting bracket in accordance with FIG. 2 and is therefore not fully engaged in it, at a high, first ultrasonic frequency,

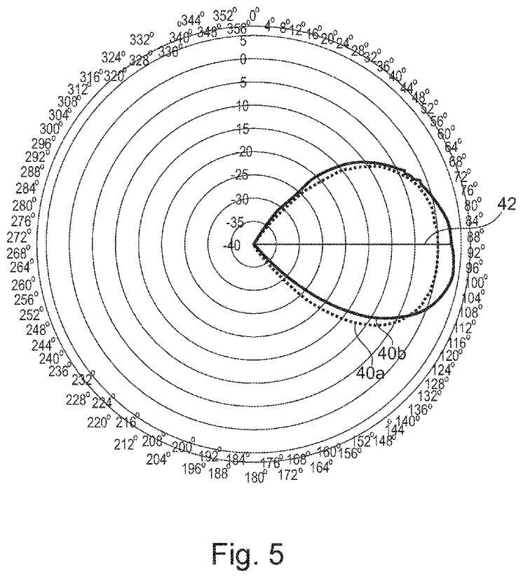

FIG. 5 shows a diagram of the detection regions of the ultrasonic sensor which is correctly positioned and engaged in the mounting bracket in accordance with FIG. 1, and of the ultrasonic sensor which is incorrectly positioned in the mounting bracket in accordance with FIG. 2 and is therefore not fully engaged in it, at a low, second ultrasonic frequency,

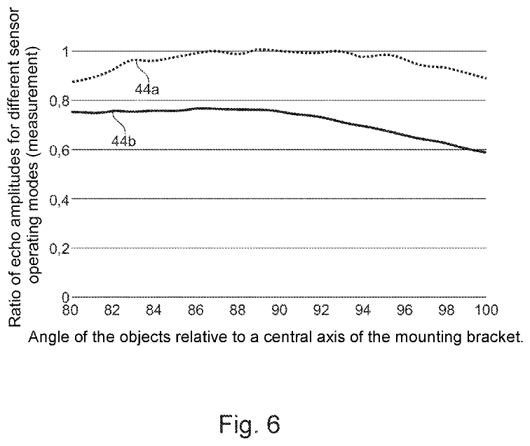

FIG. 6 shows a graph of ratios of echo amplitudes of a reference object in a first and second echo signal with the first and second ultrasonic frequency for the ultrasonic sensor which is correctly positioned in the mounting bracket and engaged in accordance with FIG. 1, and for the ultrasonic sensor which is incorrectly positioned in the mounting bracket in accordance with FIG. 2 and not fully engaged in it, as a function of an angular position of the reference object,

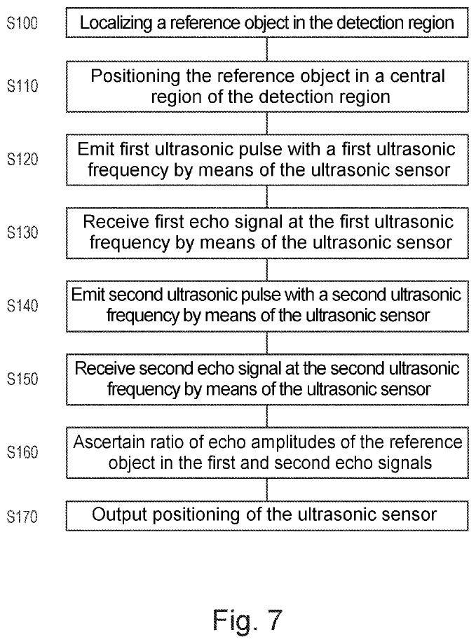

FIG. 7 shows a flow diagram of a first method for checking the positioning of the ultrasonic sensor from FIGS. 1 and 2 on a vehicle, wherein the ultrasonic sensor is installed in a mounting bracket on the vehicle,

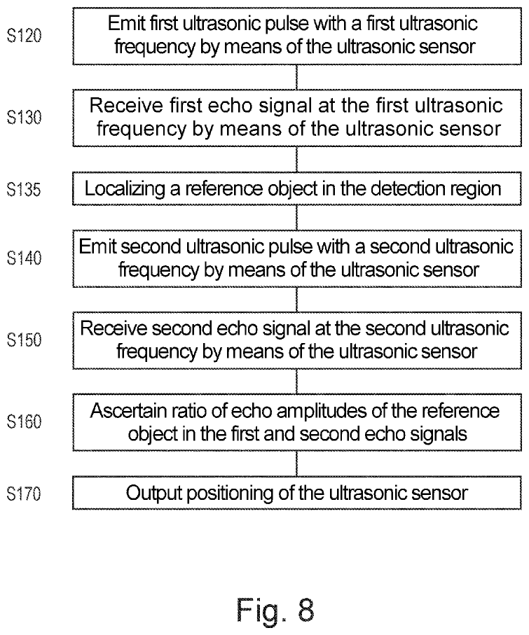

FIG. 8 shows a flow diagram of a second method for checking the positioning of the ultrasonic sensor from FIGS. 1 and 2 on a vehicle, wherein the ultrasonic sensor is installed in a mounting bracket on the vehicle, and

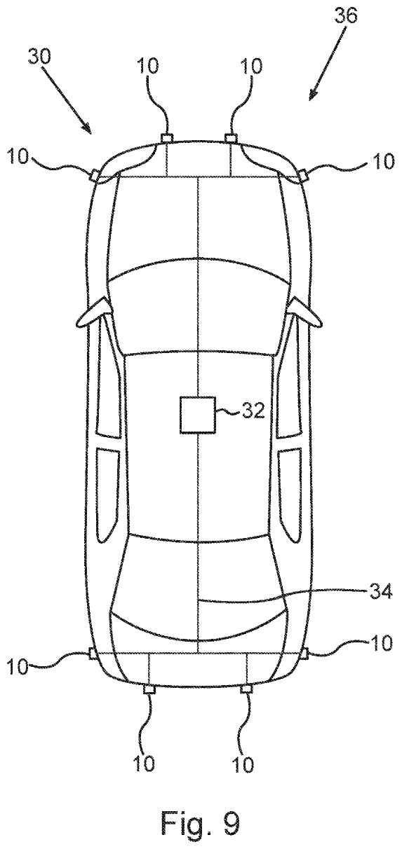

FIG. 9 shows a schematic representation of a vehicle having a sensor assembly with a plurality of ultrasonic sensors from FIGS. 1 and 2 and with a control unit connected to the plurality of ultrasonic sensors.

FIG. 1 shows an ultrasonic sensor 10 according to a first, preferred embodiment.

The ultrasonic sensor 10 comprises a sensor housing 12, on which two latching projections 14 are formed diametrically opposite each other. The ultrasonic sensor 10 additionally comprises a sensor head, which is not visible in the illustration in FIG. 1, having an ultrasonic diaphragm. A control and evaluation electronics is arranged within the sensor housing 12. The sensor housing 12 is closed with a cover 16. From a proximal end of the sensor housing 12 in FIG. 1, a plug socket 18 protrudes in the radial direction. It is understood that in other embodiments, the plug socket 18 can also protrude from the proximal end of the sensor housing at other angles.

The ultrasonic sensor 10 is accommodated in a mounting bracket 20. For this purpose, the mounting bracket 20 comprises two latching arms 22 with latch openings, not shown here. The latching arms 22 can spring in the radial direction and are used to hold and secure the ultrasonic sensor 10. When the ultrasonic sensor 10 is correctly positioned in the mounting bracket 20, both latching projections 14 engage in the corresponding openings of the latching arms 22 and the ultrasonic sensor 10 is both correctly positioned and securely held in the sensor mounting bracket 20.

The ultrasonic sensor 10 is part of a sensor arrangement 30 with a plurality of ultrasonic sensors 10 and a control unit 32, which is connected via a data connection 34 to the ultrasonic sensors 10. In principle, the control unit 32 can be any desired data processing device. In the automotive sector, so-called embedded systems are often used. The term ECU (Electronic Control Unit) is used for such control units 32. The data link 34 can comprise a bus, for example in the form of a DSI3 bus, CAN bus, FlexRay or as a proprietary implementation. In principle, however, a direct data link 34 between the control unit 32 and each of the ultrasonic sensors 10 is also possible.

The ultrasonic sensors 10 of the sensor assembly 30 in this exemplary embodiment are mounted on a rear side and a front side of a vehicle 36, as shown in FIG. 9. For this purpose, the mounting brackets 20 of the ultrasonic sensors 10 are fixed to the rear side and the front side of the vehicle 36, for example on a front or rear fender of the vehicle 36.

FIG. 2 also shows the ultrasonic sensor 10 from FIG. 1 of the first, preferred embodiment.

In contrast to the illustration in FIG. 1, however, only one of the two latching projections 14 of the ultrasonic sensor 10 engages in the corresponding opening of one of the latching arms 22. As a result, the ultrasonic sensor 10 is not correctly positioned. The consequence of this is that the ultrasonic sensor 10 is supposedly securely fixed in the mounting bracket 20, but in reality it is tilted and thus not properly positioned in the mounting bracket 20. Such an improper positioning of the ultrasonic sensor 10 in the mounting bracket 20 causes position and/or angle deviations of a sensor axis with respect to a central axis 42 of the mounting bracket 20, which can lead to incorrect functioning of the ultrasonic sensor 10 and, in addition, to malfunctions of driving assistance systems that use this ultrasonic sensor 10.

In order to be able to detect such cases of incorrect positioning, a first method for checking a positioning of the ultrasonic sensor 10 in the mounting bracket 20 on the vehicle 36, as shown in FIG. 7, is described below. The method is carried out under the control of the control unit 32. The control unit 32 can individually control each of the ultrasonic sensors 10 of the sensor assembly 30 via the data link 34 in order to carry out the method described below. The method is described with additional reference to FIGS. 3 to 6.

The method begins with step S100, which involves localizing a reference object in the detection region 40 of the ultrasonic sensor 10. The detection region 40 here defines a region in which an echo of the reference object can be received for a first and a second ultrasonic frequency. The detection region 40 is defined in relation to a correct positioning of the ultrasonic sensor 10 with its sensor axis corresponding to a central axis 42 of the mounting bracket 20, which also defines a correct positioning of the ultrasonic sensor 10. For a nominal frequency, i.e. in a medium frequency range, FIG. 3 accordingly shows detection regions 40a, 40b for a correct positioning of the ultrasonic sensor 10 in the mounting bracket 20, as shown in FIG. 1, and for an incorrect positioning of the ultrasonic sensor 10 in the mounting bracket 20, as shown in FIG. 2.

Localizing a reference object in the detection region 40 of the ultrasonic sensor 10 involves detecting a suitable reference object in the detection region 40. The object must therefore be suitable as a reference object and be located in the detection region 40 of the ultrasonic sensor 10.

For this purpose, a positioning of the reference object in the detection region 40 of the ultrasonic sensor 10 is carried out based on echo signals received with a plurality of ultrasonic sensors 10. For example, ultrasonic signals are automatically emitted from all ultrasonic sensors 10 located on the front of the vehicle 36 and echo signals based on them are received in order to carry out the method for an ultrasonic sensor 10 on the front of the vehicle 36. Distance information with respect to the reference object is detected in the echo signal and processed in order to detect the position of the reference object. For example, known methods of multilateration, in particular trilateration, are used to detect the position of the reference object in the detection region 40 of the ultrasonic sensor 10. In addition, based on the echo signals received, it is ascertained whether the object is suitable as a reference object. For this purpose, a height estimation for the object is carried out in a known manner based on the received echo signals. The reference object is preferably located in the same height range as the ultrasonic sensor 10. In addition, based on the received echo signals, a detection of walls, for example, is carried out in a known manner in order to exclude such objects. The position of the reference object is determined relative to the ultrasonic sensor 10 as an angle in a horizontal plane along with a distance.

Step S110 relates to the positioning of the reference object in a central region of the detection region 40 of the ultrasonic sensor 10, preferably in an angular range of +/−15°, further preferably in an angular range of +/−10°, and particularly preferably in an angular range of +/−5°, in particular at an angle of approximately 0° relative to a central axis 42 of the mounting bracket 20, which corresponds to a sensor axis of the ultrasonic sensor 10 when the ultrasonic sensor 10 is correctly positioned.

Based on the position of the reference object determined in step S100, an instruction to move the vehicle 36 and/or the reference object is output in order to position the reference object relative to the vehicle 36 and thus relative to the ultrasonic sensor 10. The reference object is therefore preferably positioned in conjunction with the localization of the reference object in the detection region 40 of the ultrasonic sensor 10. Accordingly, the positioning is checked again in a further step S100, and if necessary, the positioning of the reference object is also repeated until the reference object has a desired positioning in the central region of the detection region 40. Preferably, the vehicle 36 autonomously carries out the positioning relative to the reference object in order to position the reference object in the central region of the detection region 40.

Step S120 relates to emitting a first ultrasonic pulse with a first ultrasonic frequency by means of the ultrasonic sensor 10. The first ultrasonic frequency here is a frequency of approximately 59 kHz. The ultrasonic sensor 10, for example, has a nominal frequency here of 52 kHz, so that the first ultrasonic frequency is above the nominal frequency.

Step S130 relates to receiving a first echo signal at the first ultrasonic frequency by means of the ultrasonic sensor 10. Detection regions 40a, 40b corresponding to a correct positioning of the ultrasonic sensor 10 in the mounting bracket 20, as shown in FIG. 1, and to an incorrect positioning of the ultrasonic sensor 10 in the mounting bracket 20, as shown in FIG. 2, are shown in FIG. 4. Raw sensor data is received as the first echo signal. The raw sensor data is transmitted from the ultrasonic sensor 10 to the control unit 32.

Step S140 relates to emitting a second ultrasonic pulse with a second ultrasonic frequency by means of the ultrasonic sensor 10. The second ultrasonic frequency here is a frequency of approximately 46 kHz and is therefore below the nominal frequency.

Step S150 relates to receiving a second echo signal at the second ultrasonic frequency by means of the ultrasonic sensor 10. Detection regions 40a, 40b corresponding to a correct positioning of the ultrasonic sensor 10 in the mounting bracket 20, as shown in FIG. 1, and to an incorrect positioning of the ultrasonic sensor 10 in the mounting bracket 20, as shown in FIG. 2, are shown in FIG. 5. Sensor raw data, which is transmitted from the ultrasonic sensor 10 to the control unit 32, is also received as the second echo signal.

Step S160 involves determining a ratio of echo amplitudes of the reference object in the first and second echo signals. Corresponding ratios 44 are shown in FIG. 6, wherein a ratio 44a for a correct positioning of the ultrasonic sensor 10 in the mounting bracket 20, as shown in FIG. 1, and a ratio 44b for an incorrect positioning of the ultrasonic sensor 10 in the mounting bracket 20, as shown in FIG. 2, are given.

Appropriate detection and processing of levels of echo amplitudes of the reference object in the first and second echo signal is carried out. The processing takes place in the control unit 32.

Step S170 relates to outputting an error in the positioning of the ultrasonic sensor 10 if the ratio 44 of the echo amplitudes of the reference object in the first and second echo signal deviates from the ratio for a correct positioning of the ultrasonic sensor 10 by at least one specified threshold value. The output is provided by the control unit 32.

An error in the positioning of the ultrasonic sensor 10 is output if the ratio 44 of the echo amplitudes of the reference object in the first and second echo signal deviates from the ratio for a correct positioning of the ultrasonic sensor 10 by at least one predetermined threshold value, which is dependent on the position of the reference object in the detection region 40 of the ultrasonic sensor 10. As shown in FIG. 6, the curves of the ratios of the echo amplitudes are each dependent on the position of the reference object in the detection region 40 that was determined in step S100. This results in a position-dependent evaluation of the ratio of the echo amplitudes of the reference object in the received echo signals.

A second method for checking a positioning of the ultrasonic sensor 10 in the mounting bracket 20 on the vehicle 36, as shown in FIG. 8, is described below. The method is also carried out with the sensor assembly 30 described above. The method is carried out under the control of the control unit 32. The control unit 32 can individually control each of the ultrasonic sensors 10 of the sensor assembly 30 via the data link 34 in order to carry out the method described below. The second method is partly the same as the first method, so that essentially only differences between the two methods are described here.

The second method begins, as previously described with reference to the first method, with step S120 which relates to an emission of a first ultrasonic pulse with a first ultrasonic frequency by means of the ultrasonic sensor 10. The first ultrasonic frequency here is also a frequency of approximately 59 kHz. The ultrasonic sensor 10 here, by way of example, has a nominal frequency of 52 kHz, so that the first ultrasonic frequency is above the nominal frequency.

Step S130 relates to receiving a first echo signal at the first ultrasonic frequency by means of the ultrasonic sensor 10. Detection regions 40a, 40b corresponding to a correct positioning of the ultrasonic sensor 10 in the mounting bracket 20, as shown in FIG. 1, and to an incorrect positioning of the ultrasonic sensor 10 in the mounting bracket 20, as shown in FIG. 2, are shown in FIG. 4. Raw sensor data is received as the first echo signal. The raw sensor data is transmitted from the ultrasonic sensor 10 to the control unit 32.

Step S135 involves localizing a reference object in the detection region 40 of the ultrasonic sensor 10. The detection region 40 here also defines a region in which an echo of the reference object can be received for a first and a second ultrasonic frequency. The detection region 40 is defined in relation to a correct positioning of the ultrasonic sensor 10 with its sensor axis corresponding to a central axis of the mounting bracket 20, which defines the correct positioning of the ultrasonic sensor 10.

Localizing the reference object in the detection region 40 of the ultrasonic sensor 10 involves detecting a suitable reference object in the detection region 40.

Correspondingly, the reference object is determined in the first echo signal received. The first echo signal received is based on the emission of the first ultrasonic pulse with the high frequency of 59 kHz, which means that the first ultrasonic pulse is a focused ultrasonic pulse so that a narrow detection region 40 is obtained for receiving the first echo signal with the ultrasonic sensor 10.

If an echo of the reference object is contained in the first echo signal, this will be localized in the detection region 40 of the ultrasonic sensor 10. The object has a suitable positioning as a reference object, which will also allow it to be detected in the wider detection region 40 for lower frequencies.

Step S140 relates to emitting a second ultrasonic pulse with a second ultrasonic frequency by means of the ultrasonic sensor 10. The second ultrasonic frequency here is a frequency of approximately 46 kHz and is therefore below the nominal frequency of the ultrasonic sensor 10.

Step S150 relates to receiving a second echo signal at the second ultrasonic frequency by means of the ultrasonic sensor 10. Detection regions 40a, 40b corresponding to a correct positioning of the ultrasonic sensor 10 in the mounting bracket 20, as shown in FIG. 1, and to an incorrect positioning of the ultrasonic sensor 10 in the mounting bracket 20, as shown in FIG. 2, are shown in FIG. 5. Sensor raw data, which is transmitted from the ultrasonic sensor 10 to the control unit 32, is also received as the second echo signal.

Step S160 involves determining a ratio of echo amplitudes of the reference object in the first and second echo signals. Corresponding ratios 44 are shown in FIG. 6, wherein a ratio 44a for a correct positioning of the ultrasonic sensor 10 in the mounting bracket 20, as shown in FIG. 1, and a ratio 44b for an incorrect positioning of the ultrasonic sensor 10 in the mounting bracket 20, as shown in FIG. 2, are given.

Appropriate detection and processing of levels of echo amplitudes of the reference object in the first and second echo signal is carried out.

Step S170 relates to outputting an error in the positioning of the ultrasonic sensor 10 if the ratio 44 of the echo amplitudes of the reference object in the first and second echo signal deviates from the ratio for a correct positioning of the ultrasonic sensor 10 by at least one specified threshold value. In the second method, the threshold value is independent of an exact position of the reference object since the exact position was not ascertained, unlike in the 1st method.

In the second method, shown in FIG. 8, a dedicated detection mode can be omitted if the ultrasonic sensors 10 emit alternately at a high frequency and a low frequency in normal operation. This helps to avoid dead times in normal operation. This also allows for continuous checking.

### LIST OF REFERENCE SIGNS

10 ultrasonic sensor
12 sensor housing
14 latching projection
16 cover
18 plug socket
20 mounting bracket
22 latching arm
30 sensor assembly
32 control unit
34 data link
36 vehicle
40 detection region
40a detection region correct positioning
40b detection region incorrect positioning
42 central axis
44 ratio of echo amplitudes
44a ratio of echo amplitudes correct positioning
44b ratio of echo amplitudes incorrect positioning

1. A method for checking the positioning of an ultrasonic sensor on a vehicle, wherein the ultrasonic sensor is installed in a mounting bracket on the vehicle, said method comprising:
localizing a reference object in the detection region of the ultrasonic sensor;
emitting at least one first ultrasonic pulse with a first ultrasonic frequency by means of the ultrasonic sensor
receiving at least one first echo signal at the first ultrasonic frequency by means of the ultrasonic sensor,
emitting at least one second ultrasonic pulse with a second ultrasonic frequency by means of the ultrasonic sensor,
receiving at least one second echo signal at the second ultrasonic frequency by means of the ultrasonic sensor,
ascertaining the ratio of echo amplitudes of the reference object in the at least one first and second echo signal; and
outputting an error in the positioning of the ultrasonic sensor if the ratio of echo amplitudes in the reference object in the at least one first and second echo signal deviates from the ratio for a correct positioning of the ultrasonic sensor by at least one specified threshold value.

2. The method as claimed in claim 1, wherein the localizing of a reference object in the detection region of the ultrasonic sensor comprises detecting a position of the reference object in the detection region of the ultrasonic sensor based on echo signals received using a plurality of ultrasonic sensors.

3. The method as claimed in claim 1, wherein the localizing of a reference object in the detection region of the ultrasonic sensor comprises emitting at least one focused ultrasonic pulse by means of the ultrasonic sensor having a narrow detection region and receiving at least one corresponding echo signal by means of the ultrasonic sensor, wherein the reference object is localized by finding an echo of the reference object contained in the at least one received echo signal in the detection region of the ultrasonic sensor.

4. The method as claimed in claim 1, wherein the localizing of a reference object in the detection region of the ultrasonic sensor comprises detecting a position of the reference object in the detection region of the ultrasonic sensor based on a detection of the surroundings using at least one environment sensor from an optical camera, a LiDAR-based environment sensor and a radar sensor.

5. The method as claimed in claim 1, the method positioning the reference object in a central region of the detection region of the ultrasonic sensor at an angle of approximately 0° relative to a central axis of the mounting bracket of the ultrasonic sensor.

6. The method as claimed in claim 1, wherein at least one of the first ultrasonic frequency and the second ultrasonic frequency is in a frequency range below a nominal frequency of the ultrasonic sensor, and the corresponding other ultrasonic frequency is above the first ultrasonic frequency, and above the nominal frequency.

7. The method as claimed in claim 1, further comprising: repeatedly emitting the at least one first ultrasonic pulse and/or the at least one second ultrasonic pulse; and repeatedly receiving the at least one first echo signal and/or the at least one second echo signal, and ascertaining the ratio of echo amplitudes of the reference object in the at least one first and second echo signal comprises ascertaining the ratio of the echo amplitudes of the reference object based on a plurality of first and second echo signals.

8. The method as claimed in claim 1, further comprising:
determining a position of the reference object in the detection region of the ultrasonic sensor; and
outputting an error in the positioning of the ultrasonic sensor comprises outputting an error in the positioning of the ultrasonic sensor if the ratio of echo amplitudes in the reference object in the at least one first and second echo signal deviates by at least one specified threshold value from the ratio for a correct positioning of the ultrasonic sensor, which is dependent on the position of the reference object in the detection region of the ultrasonic sensor.

9. The method as claimed in claim 1, further comprising:
for determining a position of the reference object in the detection region of the ultrasonic sensor; and
outputting an error in the positioning of the ultrasonic sensor comprises outputting an error in the positioning of the ultrasonic sensor if the ratio of the echo amplitudes of the reference object in the at least one first and second echo signal deviates from the ratio for a correct positioning of the ultrasonic sensor by at least one predetermined threshold value, which is dependent on the position of the reference object in the detection region of the ultrasonic sensor.

10. A sensor assembly comprising:
at least one ultrasonic sensor; and
a control unit, which is connected via a data link to the at least one ultrasonic sensor, wherein the at least one ultrasonic sensor is installed in a mounting bracket on the vehicle,
wherein the sensor assembly is configured to perform the method for checking the positioning of an ultrasonic sensor on a vehicle as claimed in claim 1.
